(19) United States
(12) Patent Application Publication
(10) Pub. No.: US 2016/0124684 A1
(43) Pub. Date: May 5, 2016

(54) METHOD TO REALIZE OBJECT-ORIENTED IN-MEMORY DATA STORAGE AND PROCESSING

(71) Applicant: ScaleFlux, San Jose, CA (US)

(72) Inventors: Tong Zhang, Watervliet, NY (US); Hao Zhong, Los Gatos, CA (US); Fei Sun, Irvine, CA (US); Yang Liu, Milpitas, CA (US)

(21) Appl. No.: 14/925,052

(22) Filed: Oct. 28, 2015

Related U.S. Application Data
(60) Provisional application No. 62/072,909, filed on Oct. 30, 2014.

(51) Int. Cl. G06F 3/06

(52) U.S. Cl. CPC G06F 3/0688; G06F 3/0613; G06F 3/0659

(57) ABSTRACT

A system and method of providing in-memory data processing for object-oriented data with a flash memory storage. A system is disclosed that includes: a first logic process for providing intra-object data processing involving a single data object with an expansion factor greater than one; a second logic process for providing intra-object data processing involving a single data object with an expansion factor less than one; and a third logic process for providing inter-object data processing involving multiple objects.

### PRIORITY CLAIM

This application claims priority to U.S. Provisional Patent Application Ser. No. 62/072,909, filed Oct. 30, 2014, which is hereby incorporated herein as though fully set forth.

### TECHNICAL FIELD

The present invention relates to the field of data storage and processing, and particularly to providing unified in-memory data storage and processing services in computing systems.

### BACKGROUND

Object data storage is a storage architecture that organizes and manages data in the unit of variable-sized objects, as opposed to conventional storage architectures that organize and manage data in the unit of fixed-size data block/sector. NAND flash memory has been used in computing systems to realize very high-speed, high-capacity solid-state data storage at low cost. In current computing systems, dedicated integrated circuit chips, such as a CPU (central processing unit) and/or a GPU (general processing unit) implemented in a host computing system (host) handle all the data processing tasks, and storage devices, such as DRAM, solid-state drive, and hard disk drive, are only responsible for providing data storage service.

### SUMMARY

Accordingly, an embodiment of the present disclosure is directed to an infrastructure that provides object-oriented data storage and data processing services. In one aspect, a device is provided that contains one or multiple flash memory chips and an integrated circuit chip (“chip”) that manages the data storage among all the flash memory chips and carries out data processing tasks. The processing includes organizing and managing object-oriented data storage in flash memory chips, and scheduling data processing tasks.

In a further aspect, the invention provides a control/processing device for providing in-memory data processing for object-oriented data with a flash memory storage, comprising: a first logic process for providing intra-object data processing involving a single data object with an expansion factor greater than one; a second logic process for providing intra-object data processing involving a single data object with an expansion factor less than one; and a third logic process for providing inter-object data processing involving multiple objects.

In still a further aspect, the invention provides a method for providing in-memory data processing for object oriented data with a flash memory storage, comprising: receiving and processing an in-memory data processing request; utilizing a first logic process for intra-object data processing involving a single data object with an expansion factor greater than one; utilizing a second logic process for intra-object data processing involving a single data object with an expansion factor less than one; and utilizing a third logic process for inter-object data processing involving multiple objects.

In still a further aspect, the invention provides a system for providing in-memory data processing for object-oriented data with a high speed memory storage, comprising: an in-memory data processing request manager for receiving and managing processing requests from a remote host; an in-memory data processing engine having: a first logic process for providing intra-object data processing involving a single data object with an expansion factor greater than one; and a second logic process for providing intra-object data processing involving a single data object with an expansion factor less than one; and a data storage manager.

### BRIEF DESCRIPTION OF THE DRAWINGS

The numerous advantages of the present invention may be better understood by those skilled in the art by reference to the accompanying figures in which:

FIG. 1 illustrates the overall structure of the device;

FIG. 2 illustrates the control/processing chip structure in the case of intra-object data processing with expansion factor α≧1;

FIG. 3 illustrates the flow diagram in the case of intra-object data processing with expansion factor α≧1;

FIG. 4 illustrates the control/processing chip structure in the case of intra-object data processing with expansion factor α≦1;

FIG. 5 illustrates the flow diagram in the case of intra-object data processing with expansion factor α≦1;

FIG. 6 illustrates the control/processing chip structure in the case of inter-object data processing;

FIG. 7 illustrates the flow diagram in the case of inter-object data processing;

FIG. 8 illustrates the intra-group object data mapping in the case of inter-object data processing; and

FIG. 9 depicts a control processing device for carrying out object-oriented data processing and storage tasks according to an embodiment.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

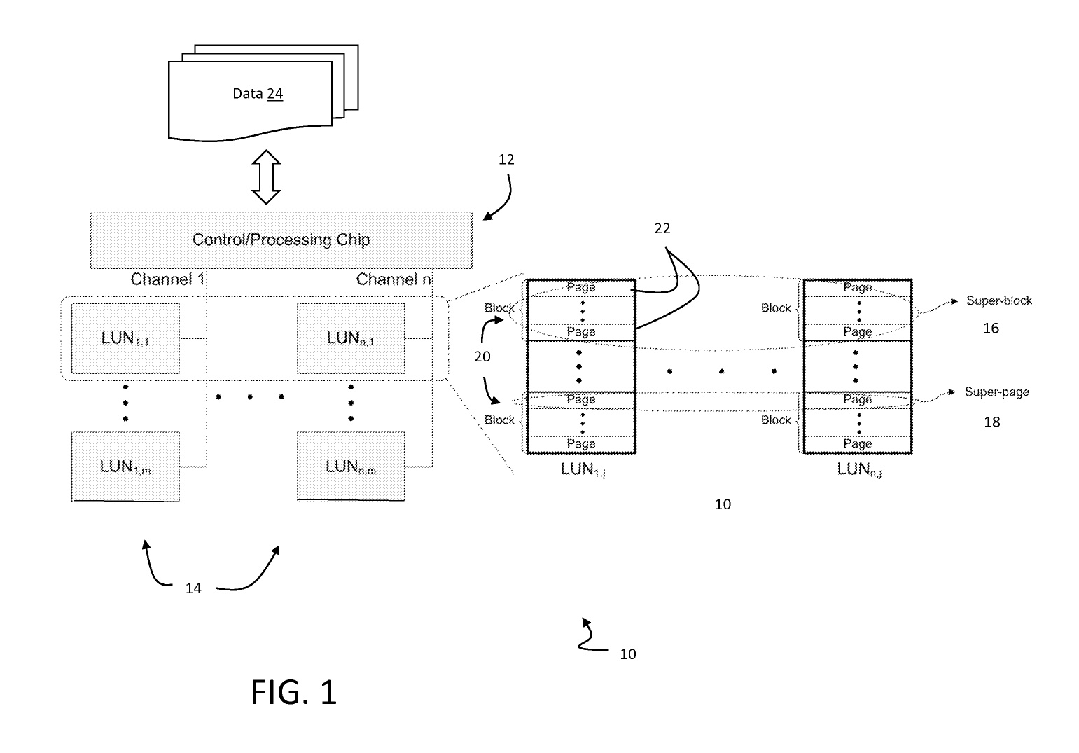

Referring now to the Figures, FIG. 1 depicts a storage device 10 that generally includes multiple flash memory chips 14 and a unified control/processing chip 12 that manages the data storage among all the flash memory chips 14 and carries out one or multiple data processing tasks. The data processing tasks involve managing and processing the data being stored in the flash memory chips of the storage device 10. Note that while the disclosure is generally directed at flash memory storage, it is applicable to any high-speed storage system capable of implementing object-oriented storage.

All the flash memory chips 14 are organized in a multi-channel structure in order to improve data access parallelism and hence data access throughput. In this embodiment, storage device 10 includes n channels, and each channel includes m logic units (LUNs). The control/processing chip 12 can access (read or write) n logic units (LUNs) or flash memory dies in parallel. As noted, on each channel there are a number of LUNs, and each LUN has a unique LUN index. Within each LUN, there are a number of flash memory blocks 20, and each block 20 has a unique block address. Within each flash memory block 20, there are a number of flash memory pages 22, each page 22 has a unique page address. As shown in FIG. 1, the n blocks, which have the same block address from the n LUNs with the same LUN index on n channels, form a super-block 16, and the n pages within each super block 16 with the same page address form a super-page 18. Data 24 can be written into a supper-page 18 in parallel across all the n channels, leading to the highest data write bandwidth.

The device 10 stores data 24 in the unit of objects. Different objects may have different size. Each object is stored in a number of consecutive super-pages 18 across one or multiple super-blocks 16. As a result, an object can be written into flash memory 14 with the highest data write bandwidth. The firmware (i.e., data storage manager) of the device 10 determines and keeps track of the mapping between each object and the physical location of the consecutive super-pages 18 that store the object.

In order to further improve efficiency, control/processing chip 12 includes logic to perform “in-memory data processing tasks,” which alleviates computational overhead of the host. The in-memory data processing tasks that are carried out by the control/processing chip 12 on the device 10 include the following three types of tasks:

1. Intra-object data processing with expansion factor α≧1: The data 24 of each object are processed independently from other objects. Let rᵢ and rₒ denote the data volume size of the object before data processing and after data processing, respectively, and define expansion factor α=rₒ/rᵢ. The expansion factor is not less than 1 in this type of processing tasks, i.e., the size of data object will not reduce after the in-memory data processing, e.g., decompression.

2. Intra-object data processing with expansion factor α≦1: The data 24 of each object are processed independently from other objects, and the data expansion factor is not greater than 1, i.e., the size of data object will not increase after the in-memory data processing, e.g., compression.

3. Inter-object data processing: The data processing task involves the data from multiple objects (e.g., logical and mathematical operations performed between different sets of data).

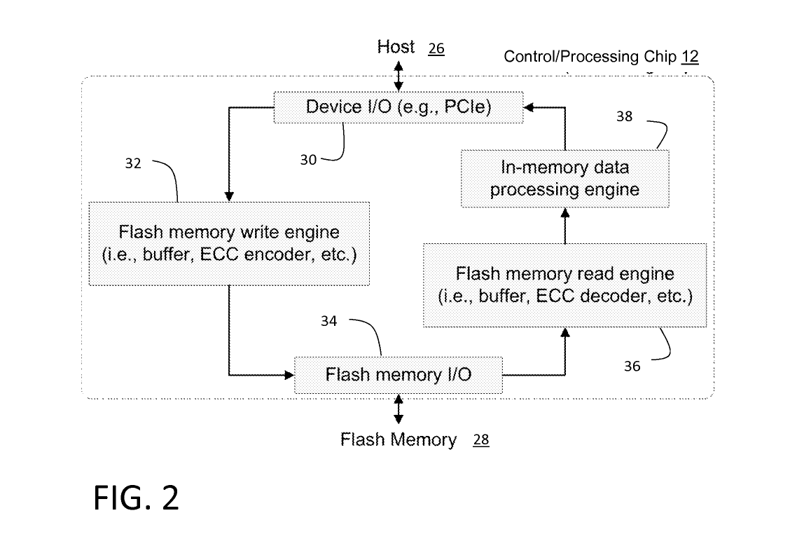

FIG. 2 depicts a process flow in control/processing chip 12 that is implemented to carry out a “type 1” in-memory data processing task (i.e., intra-object data processing task with expansion factor α≧1). As shown, during a write operation, data flows from the host 26 through the device I/O 30 and to the flash memory write engine 32. The data is then written to flash memory 28 via the flash memory I/O 34. Note that no data processing is done during a write process, i.e., chip 12 simply stores each data object in flash memory 28 without carrying out the type 1 data processing task.

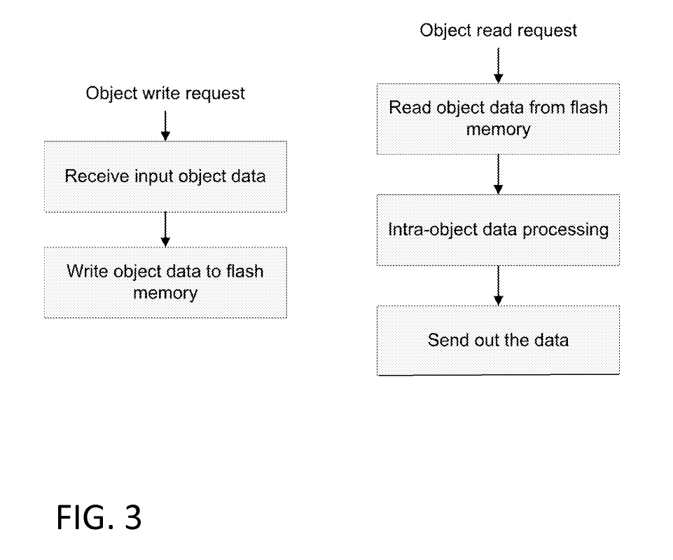

However, when a processed data object is requested by the host, the control/processing chip 12 reads the corresponding data object and carries out the data processing on-the-fly to generate the processed data object. As shown, the data object is read from flash memory 28 via flash memory I/O 34 by the flash memory read engine 36, and is then processed by the in-memory data processing engine 38. In other words, type 1 tasks are processed on the data output path. Thus, in cases where the data processing task will cause the size of the data object to grow (type 1), processing is done after data is read from memory for higher data storage efficiency. The operational flow diagram is shown in FIG. 3.

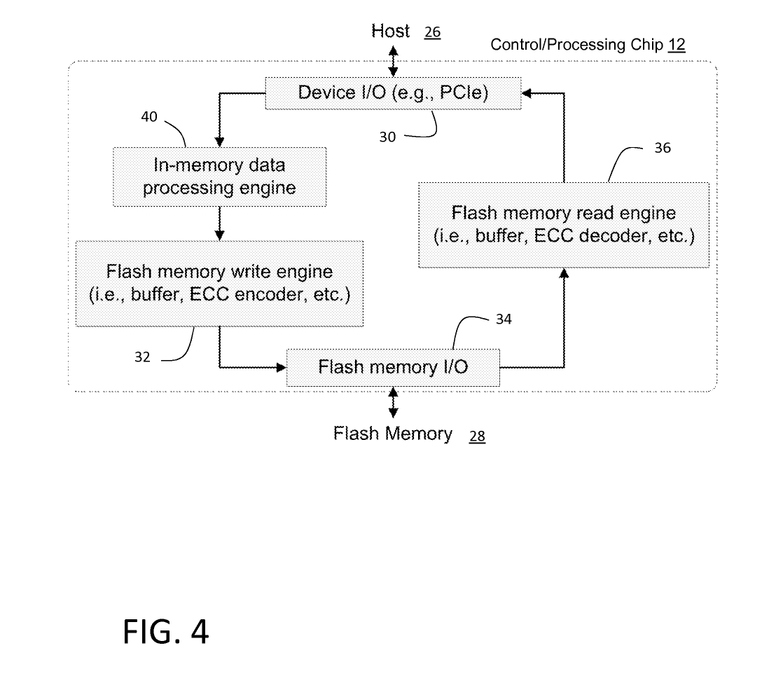

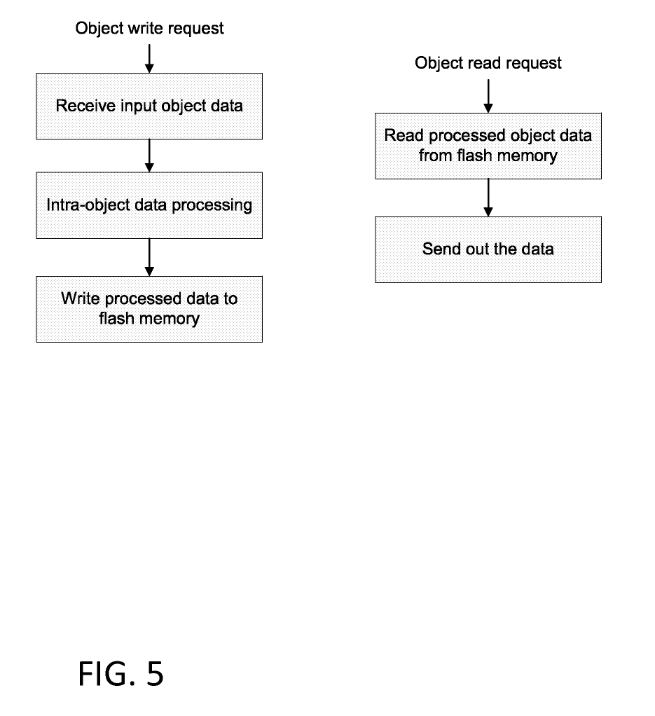

As shown in FIG. 4, when the control/processing chip 12 needs to carry out a “type 2” in-memory processing task (i.e., intra-object data processing task with an expansion less than one, i.e., factor α≦1), chip 12 implements the data processing engine 40 on the data input path, i.e., once device I/O 30 receives the input data object, it directly carries out the data processing before writing to flash memory 28, i.e., chip 12 performs an on-the-fly data processing and stores the processed (i.e., reduced size) data object in flash memory. Thus, in cases where the data processing task will cause the data object to reduce in size (type 2), processing is done before data is stored in flash memory 28 thus reducing data storage overhead. When a processed data object is requested by the host 26, the control/processing chip 12 simply reads the object from flash memory 28 and sends it out. The operational flow diagram is shown in FIG. 5.

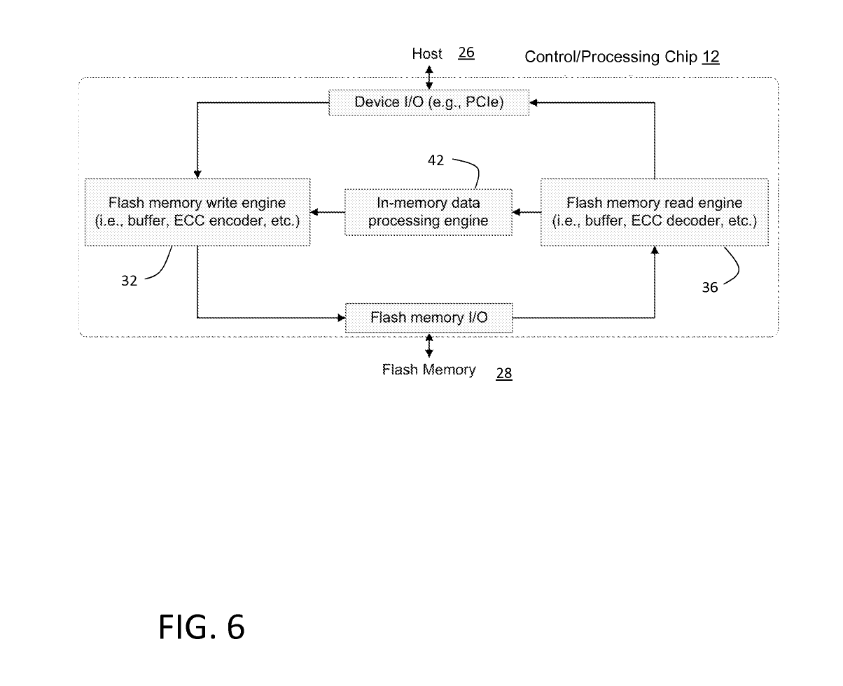

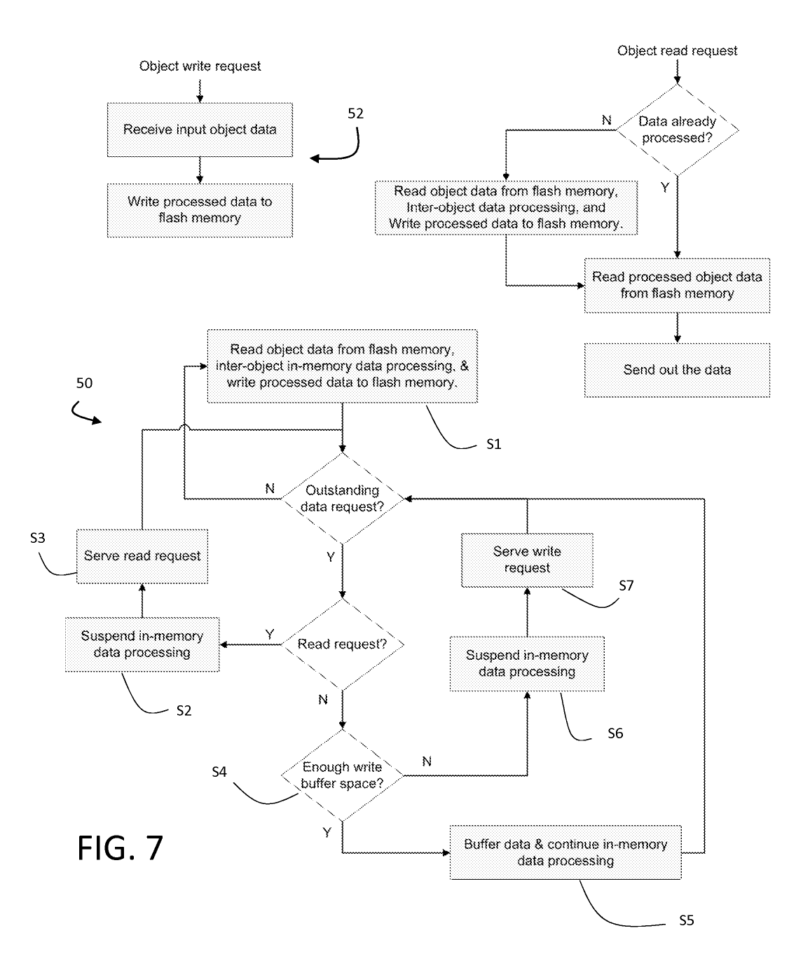

When the control/processing chip needs to carry out a “type 3” in-memory data processing task (i.e., inter-object data processing), chip 12 carries out the data processing off the direct data input/output path, as shown in FIG. 6. All the objects that are involved in each data processing task form an object processing group. The chip 12 first receives and writes each object processing group into flash memory 28 via flash memory write engine 32 (as shown in flowchart 52 of FIG. 7). Before the host 26 requests the processing results, the control/processing chip 12 carries out the in-memory inter-object data processing task using a scheduling strategy as shown in flow chart 50 of FIG. 7, which can minimize the interference of in-memory data processing on other more latency-critical data access commands issued by host.

For read requests in which data is already processed, processed data is read from flash memory as shown in flow chart 54 of FIG. 7. If requested object data was not yet processed, then the object data is read from flash memory, processed and written back to flash memory.

As shown in the scheduling flow chart 50 in FIG. 7, whenever there is no outstanding data access command issued by the host, the in-memory data processing engine 42 carries out any in-memory data processing tasks at S1. Once a data access command issued by the host arrives, if it is a data read command 50, the in-memory data processing task is immediately suspended S2, and the control/processing chip 12 attempts to serve the incoming host-issued read command as soon as possible at S3. After serving the host-issued read command, if there are no more outstanding host-issued data access commands, the control/processing chip 12 will resume and continue the in-memory data processing task.

If the host-issued command is a data write command 52, the control/processing chip 12 first tries to buffer the incoming data in on-chip or off-chip memory such as SRAM, DRAM or non-volatile memory at S4. If there is enough buffer space, the control/processing chip 12 will continue the on-going in-memory data processing task at S5, otherwise chip 12 will suspend the in-memory data processing task and serve the host-issued data write command at S6 and S7.

In the case of inter-object data processing, a further embodiment provides an inter-object data placement scheme to maximize the data write/read throughput. Recall that each super-page contains n flash memory pages. For one object being stored in s super-pages and hence s·n pages, the object is logically partitioned into s·n consecutive segments, each segment is denoted as tᵢⱼ, where index i ε [1, s] and j ε [1, n]. For data processing tasks involving a number of objects, the data processing operations are typically applied to the logical segments with the same (or proximate) index (i,j). As a result, when the data processing task is being executed, it needs to read multiple segments from different objects, which have the same index (i,j). For example, suppose an object group contains eight objects, the data processing task needs to read one segment from each object with the same index (i,j), to which certain processing operations are applied. To maximize the data processing task throughput, all the eight segments should be read from eight different channels in parallel. Therefore, segments with the same index in different objects should be stored in different channels.

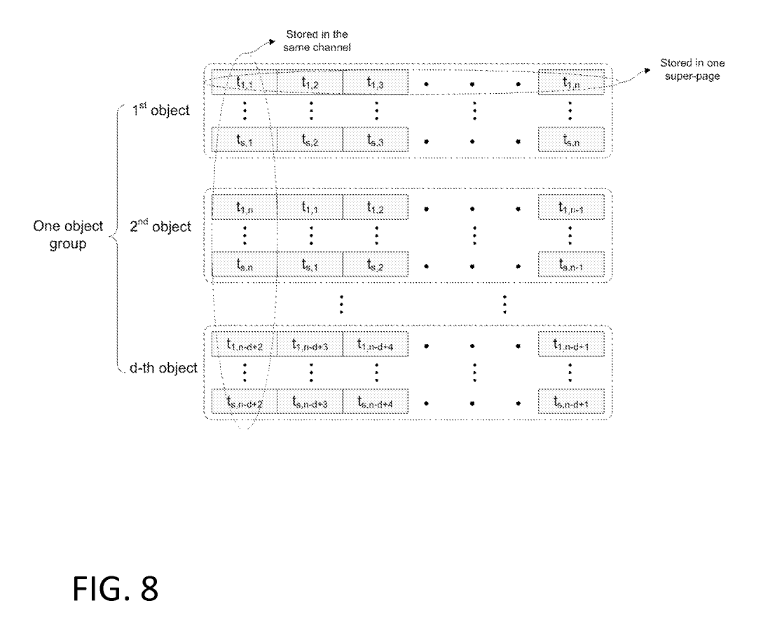

As shown in FIG. 8, the embodiment provides a skewed logical-to-physical segment mapping strategy within each object processing group. For the first object in one object group, its segment with the index (i,j) is stored in the j-th page within its i-th super-page. For the second object in the same object group, its segment with the index (i,j) is stored in the k-th page within its i-th super-page, where k=[j mod n]+1. Accordingly, for the d-th object in the same object group, its segment with the index (i,j) is stored in the k-th page within its i-th super-page, where k=[(+d−2) mod n]+1. In this way, the data processing task is served with the highest data read bandwidth, leading to the highest data processing throughput.

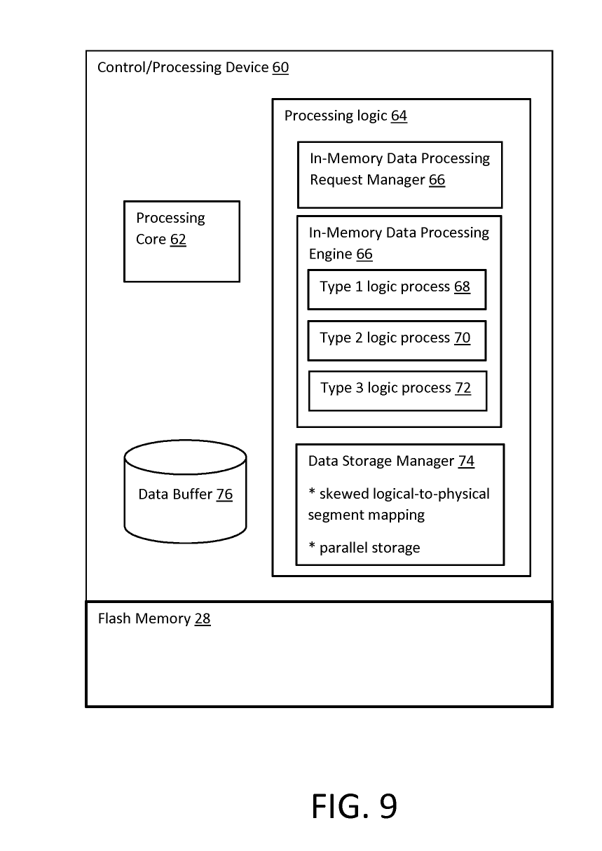

FIG. 9 depicts an illustrative implementation of a control/processing device 60 that provide in-memory data processing for data objects being stored in flash memory 28. Device 60 is generally implemented with at least one of an integrated circuit chip (“chip”), FPGA (field programmable gate array) technology, ASIC technology, firmware, software or any combination thereof. Device 60 may for example include a processing core 62, processing logic 64, and a data buffer 76. Processing logic 64 generally includes: an in-memory data processing request manager 66 the receives and manages processing requests from a host; an in-memory data processing engine 66 including logic processes 68, 70, 72 for implementing type 1, type 2 and type 3 data processing; and a data storage manager 74 that provides storage management, including the implementation of parallel storage across multiple channels and skewed logical to physical segment mapping. Data buffer 76 may be utilized for any of the processing logic 64.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by processing logic including computer readable program instructions.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A control/processing device for providing in-memory data processing for object-orient data with a flash memory storage, comprising:
a first logic process for providing intra-object data processing involving a single data object with an expansion factor greater than one;
a second logic process for providing intra-object data processing involving a single data object with an expansion factor less than one; and
a third logic process for providing inter-object data processing involving multiple objects.

2. The control/processing device of claim 1, wherein the first logic process:
causes data objects to be written to flash memory without performing in-memory data processing; and
causes data objects to be processed by an in-memory data processing engine when the data objects are read from flash memory.

3. The control/processing device of claim 2, wherein the second logic process:
causes data objects to be read from flash memory without performing in-memory data processing; and
causes data objects to processed by a second in-memory data processing engine when data objects are being written to flash memory.

4. The control/processing device of claim 3, wherein the third logic process:
causes data objects to be read from and written to flash memory without performing in-memory data processing; and
causes multiple data objects stored in flash memory, which form an object processing group, to be processed off-line.

5. The control/processing device of claim 4, wherein the third logic process utilizes a skewed logical-to-physical segment mapping strategy for storing objects within the object processing group.

6. The control/processing device of claim 1, wherein data objects are written into a super page in parallel across n channels.

7. A method for providing in-memory data processing for object-orient data with a flash memory storage, comprising:
receiving and processing an in-memory data processing request;
utilizing a first logic process for intra-object data processing involving a single data object with an expansion factor greater than one;
utilizing a second logic process for intra-object data processing involving a single data object with an expansion factor less than one; and
utilizing a third logic process for inter-object data processing involving multiple objects.

8. The method of claim 7, wherein the first logic process:
causes data objects to be written to flash memory without performing in-memory data processing; and
causes data objects to be processed by an in-memory data processing engine when the data objects are read from flash memory.

9. The method of claim 7, wherein the second logic process:
causes data objects to be read from flash memory without performing in-memory data processing; and
causes data objects to processed by a second in-memory data processing engine when data objects are being written to flash memory.

10. The method of claim 7, wherein the third logic process:
causes data objects to be read from and written to flash memory without performing in-memory data processing; and
causes multiple data objects stored in flash memory, which form an object processing group, to be processed off-line.

11. The method of claim 10, wherein the third logic process utilizes a skewed logical-to-physical segment mapping strategy for storing objects in the object processing group.

12. The method of claim 7, wherein data objects are written into a super page in parallel across n channels.

13. A system for providing in-memory data processing for object-oriented data with a high speed memory storage, comprising:
an in-memory data processing request manager for receiving and managing processing requests from a remote host;
an in-memory data processing engine having:
a first logic process for providing intra-object data processing involving a single data object with an expansion factor greater than one; and
a second logic process for providing intra-object data processing involving a single data object with an expansion factor less than one; and
a data storage manager.

14. The system of claim 13, wherein the first logic process:
causes data objects to be written to memory without performing in-memory data processing; and
causes data objects to be processed by the in-memory data processing engine when the data objects are read from memory.

15. The control/processing device of claim 14, wherein the second logic process:
causes data objects to be read from memory without performing in-memory data processing; and
causes data objects to processed by a second in-memory data processing engine when data objects are being written to memory.

16. The system of claim 13, further comprising a third logic process for providing inter-object data processing involving multiple objects, wherein the third logic process:
causes data objects to be read from and written to memory without performing in-memory data processing; and
causes multiple data objects stored in memory, which form an object processing group, to be processed off-line.

17. The system of claim 16, wherein the data storage manager utilizes a skewed logical-to-physical segment mapping strategy for storing objects within the object processing group.

18. The system of claim 13, wherein data objects are written into a super page in parallel across n channels by the data storage manager.

19. The system of claim 13, further comprising a host.

20. The system of claim 13, further comprising a scheduling strategy for managing data requests and an-memory data processing activities.
